(19) United States
(12) Patent Application Publication
(10) Pub. No.: US 2010/0036867 A1
(43) Pub. Date: Feb. 11, 2010

(54) METHOD AND SYSTEM FOR IMPROVED TRAVEL RECORD CREATION

(75) Inventor: Guy Mitchell, Aurora, CO (US)

Correspondence Address: HEWLETT-PACKARD COMPANY;Intellectual Property Administration, P.O. Box 272400, Fort Collins, CO, 80527-2400, US

(73) Assignee: Electronic Data Systems Corporation, Plano, TX (US)

(21) Appl. No.: 12/189,706

(22) Filed: Aug. 11, 2008

(51) Int. Cl. G06F 17/30

(52) U.S. Cl. 707/102; 707/E17.009

(57) ABSTRACT

A method for travel record creation. The method includes receiving initial passenger name record (PNR) data in a travel management system, retrieving stored PNR data corresponding to the initial PNR data by a business intelligence (BI) engine, and automatically creating and storing a PNR, by the BI engine, according to the initial PNR data and the stored PNR data. There is also a travel management system including a BI engine and a database. The travel management system is configured to receive initial passenger name record (PNR) data. The BI engine is configured to retrieve stored PNR data corresponding to the initial PNR data and automatically create and store a PNR according to the initial PNR data and the stored PNR data.

### TECHNICAL FIELD

The present disclosure is directed, in general, to systems and methods for processing travel records.

### BACKGROUND OF THE DISCLOSURE

In the transportation industry, Passenger Name Records (PNRs) are commonly created by agents by adding a name field, a phone number, an itinerary item, a received field, a fare, and is ended by an end transaction (ET or ER) to file the record down. Some fields are mandatory, some are not. There is no set order for the fields, as they can be added in any order. The records are created in different platforms, i.e., they can be added via text-based “green screen” or they can be added via GUI interface.

### SUMMARY OF THE DISCLOSURE

A disclosed embodiment includes a method for travel record creation. The method includes receiving initial passenger name record (PNR) data in a travel management system, retrieving stored PNR data corresponding to the initial PNR data by a business intelligence (BI) engine, and automatically creating and storing a PNR, by the BI engine, according to the initial PNR data and the stored PNR data.

Another disclosed embodiment includes a travel management system including a BI engine and a database. The travel management system is configured to receive initial passenger name record (PNR) data. The BI engine is configured to retrieve stored PNR data corresponding to the initial PNR data and automatically create and store a PNR according to the initial PNR data and the stored PNR data.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a block diagram of a travel management system in accordance with a disclosed embodiment; and

FIG. 3 depicts a flowchart of a process in accordance with a disclosed embodiment.

### DETAILED DESCRIPTION

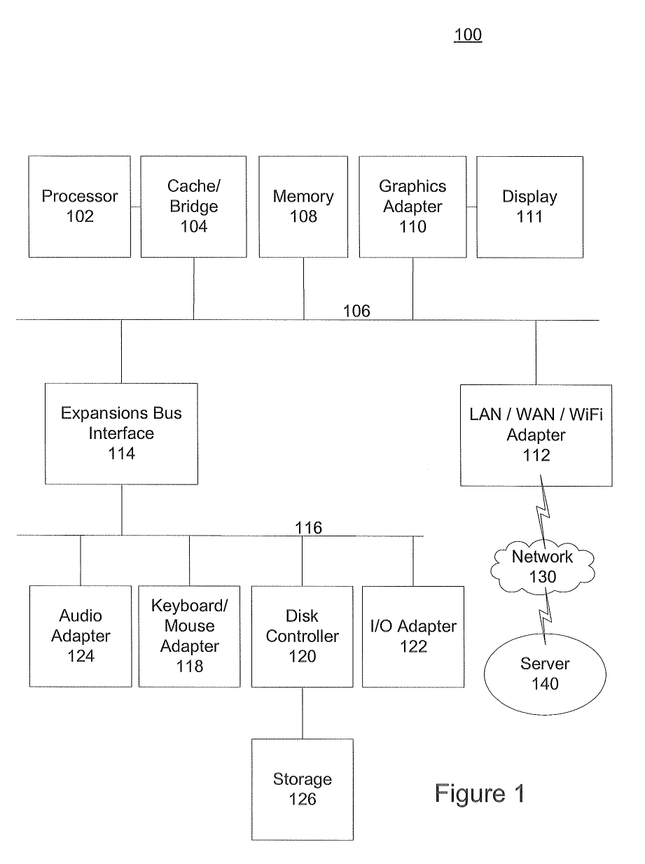

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

When calling an airline or a travel agent, it is not atypical for a Passenger Name Record (PNR) creation to take 30-60 minutes to be created from beginning to end of transaction (ET), where the PNR is then stored within the mainframe computer system. The mainframe system is the system of choice because it is able to handle a large volume of transactions. While the mainframes are able to handle large volumes, the number of entries an agent inputs to complete a transaction is based on the ability of the agent to ask questions and type in the responses. Once the agent completes a transaction, the agent then typically begins a new transaction with a new customer, repeating the process.

One improvement for PNR creation includes the use of fill-in formats. A browser-based product can simplify how these entries could be entered. Once an entry has been created, the browser has the capability to save the fields that were previously entered so the agent would no longer have to physically re-enter those fields. Instead, the fields can simply be re-retrieved to be re-entered.

Disclosed embodiments enable PNRs to be created even more efficiently through previously stored information and through the use of business intelligence processes in data processing system.

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

A sample Passenger Name Record (PNR) build in its simplest form is illustrated below. Typically, an agent signs into the system and enters password (or performs other authentication process):

SIxxxxxxx

The agent then creates a record by entering a series of field codes and a corresponding data entry for each field:

| | |
|---|---|
| N: John Smith <enter> | (This is the required name field) |
| P: 303-555-5555 <enter> | (This is the required phone field) |
| T: TL1200 <enter> | (This is the required telephone field) |
| JR.B | (This is the fare quote field) |
| R: Agent's name | (This is the required received field for the agent |
| | who creates the record) |
| ER | (This is the required End Transaction, which |
| | will file the record and redisplay the record) |

The example above does not include adding the flights, which must be done prior to the End Transaction. It also does not include adding the address, credit card information, or other items that are important to a PNR. The preceding example shows a PNR created in its simplest form.

Most records are not this simple because the agent usually has to search for the best fare, look for different itinerary options, etc. However, each time the agent finds something, the agent will refile the record. Because most records that are built are not this simple, a tool to look for user patterns becomes more important.

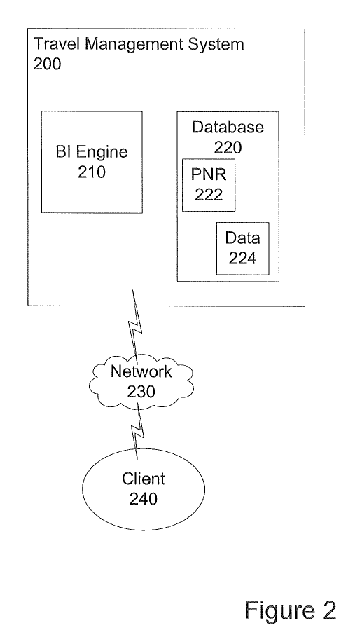

FIG. 2 depicts a block diagram of a travel management system in accordance with a disclosed embodiment. Travel management system 200 can be implemented as a data processing system 100, described above, and also includes a Business Intelligence (BI) engine 210 and a database 220. BI engine 210 can be a dedicated controller in some embodiments, and can be implemented using processor 102 in some embodiments. Travel management system 200 is capable as performing as a conventional system for processing travel records, and has additional functions and capabilities as described herein. The BI source may or may not come from within the Travel Management System, and can include external rules or information, such as caller ID or voice recognition. Thus, a BI source might also exists outside of the TMS, and is included within the scope of the disclosure.

In some stand-alone embodiments, interactions with users are performed directly by travel management system 200. In other embodiments, travel management system can also, or alternately, interact with users via client data processing system 240 and network 230. In some embodiments, a user of client 240 can use a standard thin-client browser, such as the INTERNET EXPLOROR browser or the MOZILLA FIREFOX browser, to communicate over network 230 with travel management system. While only a single client system 240 is shown in this figure, those of skill in the art will recognize that in some embodiments, multiple clients 240 will communicate with travel management system 200 to allow users to perform the interactions described herein.

According to disclosed embodiments, a PNR can be built with pre-existing information, so that the build process can be performed done much more quickly. For instance, if the name is input to travel management system 200 using a N:John Smith, a Business Intelligence (BI) engine 210 can be invoked to pull up John Smith's previously built PNRs from database 220 or several other sources, such as an online address and phone number database, for address information, phone numbers, and other information. The BI engine 210 can then use this information to build the PNR and automatically enter an ER to end the transaction. The PNR 222 then can be stored in database 220, transmitted to another system, printed, displayed, or some combination of these.

For example, a PNR can be created using a BI engine 210 as described in the examples below. In a first example, the agent signs into the system and enters password:

SIxxxxxxx

The agent then begins to create a record by entering at least one field code and a corresponding data entry for each field:

N: John Smith <enter> (This is the required name field)

The BI engine 210 then recognizes the name John Smith, or other fields that may have been entered, and begins adding information, such as a phone field, address field, spouse and child names, previous credit cards, etc., all which may be part of data 224. The BI engine 210 builds the PNR using this information and ETs the record, including storing the PNR and optionally re-loading it for further manual edits by the agent or user. The or user can then use the PNR created by the BI engine to perform any further tasks, such as adding an airline reservation.

In a second example, when the phone number is picked up by the reservations agent, the BI engine 210 or travel management system 200 receives the telephone number and/or caller name from the “caller ID” functions of the call or telephone system. The BI engine 210 retrieves stored information corresponding to the telephone number, e.g. from database 220, and automatically begins creating the PNR based on the recognized phone number, adding the passengers that are might be associated to that number. In this example, other fields such as the phone number, address field, credit card, and names of the passengers can be input into the PNR from the information retrieved from database 220 while the agent is initially greeting the caller.

Different systems recognize phone numbers when a person makes a phone call. That data could be transferred to the BI engine 210 for entry into the PNR, and can be used by the BI engine 210 for retrieving other information for building the PNR. If the data was incorrect, the data could easily be changed, but it would not slow the process of building John Smith's record. According to disclosed embodiments, the PNR is built much more quickly using the BI engine. This allows the travel agent to service more customers in a given period of time.

According to disclosed embodiments, the BI engine can also learn detect and exploit an airline agent or the travel agent's previous patterns for creating a record, and store those patterns as part of data 224. While a PNR can be built several different ways, most agents follow patterns to create a PNR, e.g., repeating the same steps A through Z before ET'ing a PNR. A different agent may build the PNR entirely differently, e.g., repeating steps Z through Q for each PNR.

In most conventional systems, for most of the PNR, there is no set pattern required as long as all the fields are entered before the ET. According to disclosed embodiments, the BI engine 210 can learn and store the user's patterns, for example, based on their individual profile. The BI engine 210 can then use the pattern to help the agent complete the transaction. For instance, in the case where the normal user pattern was to enter the same steps A through Z before ET'ing a PNR, assume that the user performs steps as follows:

Step A <enter>

Step B <enter>

Step C <enter>

Here, in accordance with disclosed embodiments, the BI engine 210 can recognize that steps D-Z were coming, and BI engine could complete the rest of the transactions corresponding to Steps D-Z, based on the learned pattern. A particular user may have several patterns that they follow to build a PNR, so BI can recognize all the patterns and store them.

The embodiments disclosed herein do not depend on any specific fill-in formats on the input fields. Data obtained through previously built records, auto stores, or any of the transactions learned by the BI engine could be stored in data 224 and used to help populate those agents that use fill-in formats, and can be used in direct-entry systems.

Having a method and system where the agent's learned user patterns can save time and speed up the transactions of the agent.

In other embodiments, using the BI engine 210 and stored transaction patterns, the creation of travel records is largely automated, for a virtual “One Touch Travel”. Here, a user can sign into a browser or GUI based application, click on the desired travel destination, and have a travel record or PNR record built automatically because the exact same (or substantially similar) record has been built before.

For example, consider a conventional process for creating a PNR including flight information. First, an agent signs into the system and enters password:

SIxxxxxxx

Next, the agent manually creates the PNR”

Creates a record:

| | |
|---|---|
| N: John Smith <enter> | (This is the required name field) |
| P: 303-555-5555 <enter> | (This is the required phone field) |
| T: 8885551212 <enter> | (This is the required telephone field) |
| 11FEBDENTUL | (This is an entry to check the availability of |
| | flights from Denver to Tulsa on 01 February) |
| 01Y1 | (This will book that flight) |
| JR.B | (This is the fare quote field) |
| R: Agent Jones | (This is the required received field for the agent |
| | who creates the record) |
| ER | (This is the required End Transaction, which |
| | will file the record and redisplay the record) |

Of course, most entries are not this simple, but most of these entries are identical for the next traveler going to the same destination

According to a disclosed embodiment, the process can be much simplified using the BI engine. In this example, a user's browser pops up where the user sees the following options:

DenverTulsaNextDayAM

DenverTulsaNextDayPM

TulsaDenverNextDayAM

TulsaDenverNextDayPM

The user, a frequent traveler in Denver, has business in Tulsa and needs to get there tomorrow morning. He clicks the DenverTulsaNextDayAM option, where the learned entries are created and his record is built by the BI engine with one touch of the button. The entries were learned because the traveler or his administrative assistant had repeatedly entered the transactions.

Similarly, a travel agent or the airline help desk benefit from a similar technique because they book PNRs all day. Thus, based upon their sign in, a “learned” profile helps them speed up their entries.

The disclosed embodiments can saves time for travelers and agents. Thin-client browser access over a network allows for more access to the product for users. Faster creation of records allows for more revenue for clients.

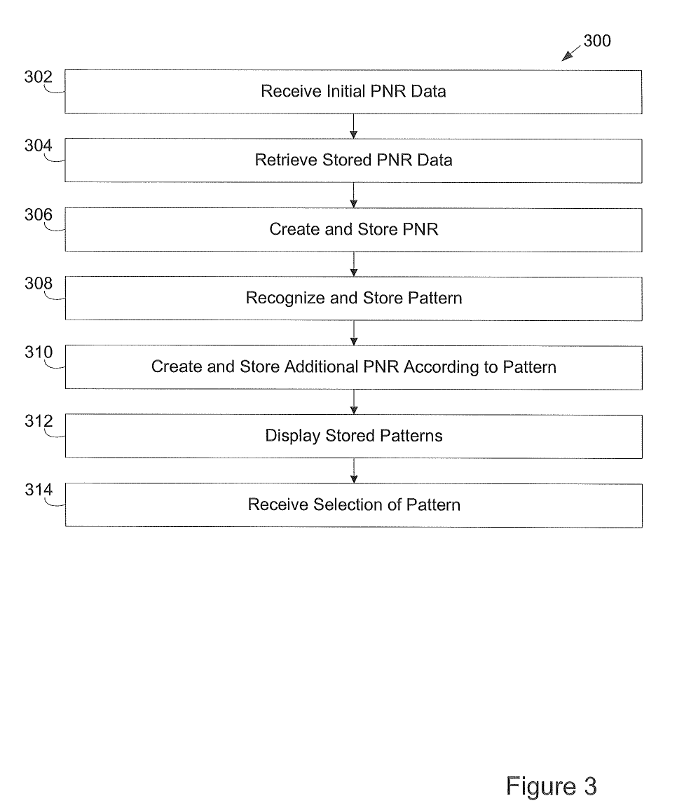

FIG. 3 depicts a flowchart of a process in accordance with a disclosed embodiment, as can be performed by a travel management system 200 and BI engine 210.

First, the system receives initial passenger name record (PNR) data (block 302). This can be direct entry from a user, loading from a storage, or can be by any method by which the PNR data can be retrieved, and can include information retrieved via “caller ID”, voice recognition, or other means to identify the potential customer, matching that data to previously stored PNRs, etc. For example, caller ID could identify the name, phone number, and address, which could be matched to previously stored PNRs.

The system retrieves stored PNR data corresponding to the initial PNR data (block 304). This retrieval can be from a local database, or can be from other databases located on other systems or networks.

The system automatically creates and stores a PNR according to the initial PNR data and the additional PNR data (block 306).

The system recognizes and stores a pattern according to the created PNR (block 308).

The system thereafter creates and stores additional PNRs according to the stored pattern and the initial PNR data (block 310). In some embodiments, this step can be performed in addition to, at the same time as, or instead of, or as a part of steps described in blocks 304 and 306. That is, if a pattern has already been stored, then when the initial PNR data is received, the system can the automatically create a PNR according to the stored pattern and the initial PNR data. The stored pattern of previous PNR records can be included as the stored PNR data.

The system can also display stored patterns using known means such as icons, buttons, or text (block 312). The system can receive a selection of a stored pattern (block 314) and automatically create a PNR based on the selected stored pattern (block 316).

Those of skill in the art will recognize that in practice, some of the steps described above may be performed concurrently or in a different order. In some instances, one or more steps may be omitted, or different or additional processes can be performed. Any of the data or PNRs described above can be transmitted, printed, displayed, or otherwise used to produce a useful, concrete, and tangible output in addition to or instead of being stored.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for travel record creation, comprising:
receiving initial passenger name record (PNR) data in a travel management system;
retrieving stored PNR data corresponding to the initial PNR data by a business intelligence (BI) engine; and
automatically creating and storing a PNR, by the BI engine, according to the initial PNR data and the stored PNR data.

2. The method of claim 1, further comprising:
recognizing, by the BI engine, a pattern according to the created PNR; and
automatically creating and storing an additional PNR according to the initial PNR data and the pattern.

3. The method of claim 1, wherein the stored PNR data includes a stored pattern of previous PNR records.

4. The method of claim 1, wherein the initial PNR data includes a passenger name.

5. The method of claim 1, wherein the initial PNR data includes caller ID information received from a telephone system.

6. The method of claim 1, wherein the initial PNR data includes information determined from voice recognition.

7. The method of claim 1, further comprising:
recognizing, by the BI engine, a pattern according to the created PNR;
storing the pattern; and
in response to a selection of the stored pattern, automatically creating and storing an additional PNR according to the initial PNR data and the stored pattern.

8. The method of claim 1, wherein the initial PNR data is received over a network.

9. A travel management system comprising a business intelligence (BI) engine and a database,
wherein the travel management system is configured to receive initial passenger name record (PNR) data, and
wherein the BI engine is configured to retrieve stored PNR data corresponding to the initial PNR data and automatically create and store a PNR according to the initial PNR data and the stored PNR data.

10. The travel management system of claim 9, wherein the BI engine is also configured to recognize a pattern according to the created PNR and automatically create and store an additional PNR according to the initial PNR data and the pattern.

11. The travel management system of claim 9, wherein the stored PNR data includes a stored pattern of previous PNR records.

12. The travel management system of claim 9, wherein the initial PNR data includes a passenger name.

13. The travel management system of claim 9, wherein the initial PNR data includes caller ID information received from a telephone system.

14. The travel management system of claim 9, wherein the BI engine is also configured to recognize a pattern according to the created PNR, store the pattern, and, in response to a selection of the stored pattern, automatically create and store an additional PNR according to the initial PNR data and the stored pattern.

15. The travel management system of claim 9, wherein the initial PNR data is received over a network.

16. A machine-useable medium encoded with machine-useable and executable instructions, comprising:
instructions for receiving initial passenger name record (PNR) data in a travel management system;
instructions for retrieving stored PNR data corresponding to the initial PNR data by a business intelligent (BI) engine; and
instructions for automatically creating and storing a PNR, by the BI engine, according to the initial PNR data and the stored PNR data.

17. The machine-useable medium of claim 16, further comprising:
instructions for recognizing, by the BI engine, a pattern according to the created PNR; and
instructions for automatically creating and storing an additional PNR according to the initial PNR data and the pattern.

18. The machine-useable medium of claim 16, wherein the stored PNR data includes a stored pattern of previous PNR records.

19. The machine-useable medium of claim 16, wherein the initial PNR data includes a passenger name.

20. The machine-useable medium of claim 16, wherein the initial PNR data includes caller ID information received from a telephone system.

21. The machine-useable medium of claim 16, further comprising:
instructions for recognizing, by the BI engine, a pattern according to the created PNR;
instructions for storing the pattern; and
instructions for automatically creating and storing an additional PNR according to the initial PNR data and the stored pattern in response to a selection of the stored pattern.

22. The machine-useable medium of claim 16, wherein the initial PNR data is received over a network.
